(19) United States
(12) Patent Application Publication
(10) Pub. No.: US 2024/0123681 A1
(43) Pub. Date: Apr. 18, 2024

(54) DEVICE FOR ADDITIVE MANUFACTURING

(71) Applicant: SOMIC VERPACKUNGSMASCHINEN GMBH & CO. KG, Amerang (DE)

(72) Inventors: Christoph Kögel, Prutting (DE); Egbert Classen, Schonstett (DE)

(21) Appl. No.: 18/484,568

(22) Filed: Oct. 11, 2023

(30) Foreign Application Priority Data
Oct. 13, 2022 (EP) 22201264.3
Oct. 2, 2023 (EP) 23201267.4

(51) Int. Cl. B29C 64/236; B29C 64/209; B29C 64/232

(52) U.S. Cl. CPC B29C 64/236; B29C 64/209; B29C 64/232; B33Y 30/00

(57) ABSTRACT

The invention relates to a device for additive manufacturing of a component not belonging to the device. The device includes a print head unit, a print bed unit, and a system formed in magnetic levitation technology having a stator assembly and at least one mover. According to the invention, the print head unit is formed on a surface of the at least one mover facing a printing surface.

### CROSS REFERENCE TO RELATED APPLICATIONS

This application claims priority to European Patent Application No. 22 201 264.3, filed in Europe on Oct. 13, 2022 and to European Patent Application No. 23 201 267.4, filed in Europe on Oct. 2, 2023, which are herein incorporated by reference in their entireties for all purposes.

### TECHNICAL FIELD

The invention relates to a device for additive manufacturing of a component not belonging to the device, comprising: a print head unit which is arranged to apply a printing medium intended for forming the component to a printing surface, a print bed unit with a surface facing towards the print head unit, on which surface the printing surface is formed, a system formed in magnetic levitation technology with a stator assembly and at least one mover, the stator assembly having a movement surface relative to which the at least one mover is movable. It should already be noted at this point that the stator assembly comprises at least one stator unit.

### BACKGROUND

Such a device for additive manufacturing is known from the generic US 2020/0030995 A1. In this device, several movers are connected to each other via a complex connecting body on which the printing surface is formed. The print head unit is either rigidly positioned or movable using additional actuators. The connecting body has a complex construction with which the movers are connected and the relative movement between the movers is restricted or compensated. The device known from US 2020/0030995 A1 for additive manufacturing of a component is therefore cost-intensive, and the synchronized control of multiple movers is costly and complex. Due to its height, the structure can bend, which can lead to greater inaccuracies in the positioning of the printing surface and/or the component to be manufactured than in other known devices for additive manufacturing.

Furthermore, US 2020/0030995 A1 describes a stator assembly relative to whose movement surface multiple movers can move simultaneously. In order to prevent the movers from obstructing each other during their work sequence, the movement surface is divided into different movement areas, with each mover being assigned a movement area. A working field can extend over a plurality of stator units.

Another device for additive manufacturing of a component is known from EP 3 290 187 A1, which comprises a superconductor that is firmly coupled to a magnetic field generator in the horizontal direction via a frozen magnetic field caused by the superconductor. Separate means are provided for movement in the horizontal direction, which move the magnetic field generator and thus the superconductor, the print head and the printing surface. Thus, this device is complex and costly and has a high weight.

### SUMMARY

It is the problem of the present invention to provide a device for additive manufacturing with a simplified structure.

This problem is solved by a device of the type mentioned at the beginning, in which the print head unit is formed on a surface of the at least one mover facing towards the printing surface. In that the print head unit is formed directly on a surface of the at least one mover, the device has a simplified structure. In other words, the print head unit is formed hanging above the printing surface on the at least one mover. The at least one mover can be positioned very precisely and flexibly on the movement surface, so that the positioning and movement of the print head unit relative to the printing surface can be improved and performed with greater accuracy. Accordingly, time-consuming adjustment of the printing surface and the print head unit relative to a zero point of the device is also eliminated. Thus, throughput times and handling times can be reduced. Furthermore, the device according to the invention is particularly suitable for the production of heavy components. The use of containers with material from which the component is produced by the use of the printing medium is also possible in a simple manner with the device according to the invention.

The movement surface limits the dimensions of the component to be built up in a plane parallel to the movement surface. An increase in the maximum possible dimensions of the component in this plane can be achieved simply by increasing the movement surface. In conventional devices for additive manufacturing, an increase in the maximum possible component dimensions is accompanied by an increase in the bending moment acting on the device. The adaptation of the components of the device required for compensation leads to a disproportionate increase in costs. With the device according to the invention, the stability of the printing surface can be increased in a simple and thus cost-effective manner. The device is thus also suitable for use in an additive manufacturing process in which the printing surface has to bear an increased weight, for example a manufacturing process in which the printing medium is arranged in a container, for example powdered or liquid material or resin, such as epoxy resin. The device according to the invention is also particularly suitable for manufacturing heavy components.

In the context of the present invention, the term “printing medium” includes any medium suitable for producing a component by means of additive manufacturing. Thus, the print head unit may be a unit suitable for applying molten material to the printing surface, or a unit suitable for applying liquid material to the printing surface, or a unit suitable for applying bonding material to the printing surface, or a unit suitable for applying light, such as light from a laser, to the printing surface, or a unit suitable for applying an electron beam to the printing surface, or the like. Also, a unit that leads to the production of a component by the application of thermal radiation, similar to a thermal printer or similar to fire painting in wood, can be a print head unit.

The print bed unit can be both a unit on whose surface facing towards the print head unit. Further, the print bed unit may be a print bed container. A material may be arranged in the printing bed container, in which the component is produced by applying the printing medium. In particular, the component is produced in layers.

If the print bed unit is designed as a print bed container, the printing surface may also be arranged inside the print bed container.

The number of print media that can be used can be increased if the print head unit can be heated. Furthermore, the flexibility of use of the device can be increased by the print head unit comprising a mirror deflection unit.

The print head unit can be integrally formed with the at least one mover. Alternatively, the print head unit can be operationally fixed and detachably connected to the at least one mover, for example via a form-fit and/or frictionally connected connection, preferably by means of a screw connection and/or a bolt connection and/or a snap-in connection and/or a magnetic connection. A material-locking connection, for example a welded connection and/or an adhesive connection and/or a soldered connection and the like, can also be provided to connect the print head unit to the at least one mover.

At this point, it should be noted that the mover may move on the movement surface in either the horizontal direction or the vertical direction. By horizontal direction is meant any direction extending parallel to the movement surface, for example the transverse direction and the longitudinal direction. The vertical direction extends orthogonally to the movement surface and thus to the horizontal direction. The vertical direction can also be referred to as the height direction. If the magnetic field of the stator unit is adjusted accordingly, the mover may have an inclined position relative to the movement surface. For example, a level mover may have a smaller distance to movement surface in horizontal direction at one position than at another position. Further, it is conceivable that the movement surface may be inclined relative to the print bed unit.

The print head unit may be attached to the at least one mover in such a way that it protrudes vertically downwards from the at least one mover in the direction of the printing surface. This may also be referred to as a hanging attachment. This facilitates the application of the printing medium by utilizing gravity.

It is understood that the at least one mover is movable both during the manufacturing process and before and after it. The manufacturing process is defined as the process in which printing medium is applied to the printing surface in order to additively manufacture a component. Since building up a component in layers is characteristic of additive manufacturing, the term “applying to a printing surface” includes not only applying a first layer of material directly to the printing surface, but also applying further layers of material to one or more layers of material already on the printing surface. Similarly, the device can be used to apply printing medium to a component already on the printing surface prior to the start of the manufacturing process in order to produce a predetermined shape. In this case, too, the print head unit applies printing medium to a printing surface in order to manufacture a component, namely to a semi-finished product located on the printing surface. This can be advantageous, for example, for repairs or to continue an interrupted manufacturing process.

It should also be noted that the device can also build up a plurality of components on one and the same printing surface.

At this point, it should be noted that the at least one mover may have a plurality of permanent magnets, preferably four permanent magnets at the corners and a fifth permanent magnet at the center. In contrast, the stator assembly has electromagnets via which the stator assembly generates a magnetic field to control the position and, if necessary, the movement of the at least one mover in the horizontal and vertical directions. The vertical movement of the at least one mover is controlled by the strength of the magnetic field of the stator arrangement.

For example, in the event of a power failure or failure of one or more of the electromagnets, the at least one mover may become detached from the movement surface. In this case, to prevent the at least one mover and/or the print head unit formed thereon from falling onto the component and damaging or destroying the component and/or itself, the device may further comprise a holding unit arranged to hold the at least one mover on the movement surface.

In particular, the holding unit may comprise a suction device that can be activated by a signal and/or has a self-holding function. The holding unit may comprise a conventional holding device.

In a further development of the invention, it is proposed that the at least one mover can be movable relative to the movement surface both in the horizontal direction and in the vertical direction.

The possible range of motion in the vertical direction of currently known magnetic levitation technology systems is limited. The resulting limited dimensions are nevertheless sufficient for certain components with a rather flat design. In addition, systems are under development that allow a larger range of motion in the height direction of the at least one mover. By using such systems, a component with greater vertical extension can be formed.

In principle, it is conceivable for the print head unit to be completely rigid. Prior art print head units with mechanical height adjustment by means of a spindle drive have a large vertical printing range, but only a low accuracy of the height adjustment. For example, a height adjustment with a resolution in the vertical direction of 10 μm to 20 μm can theoretically be used, but in practice only a gradation of adjustability of about 50 μm is realistically used. The accuracy of magnetic height adjustment of the at least one mover on the movement surface using magnetic levitation technology, on the other hand, is significantly better, for example in the order of 2 μm. In order to increase the printing area in the vertical direction, and consequently also the vertical extent of the component to be manufactured, while taking advantage of the high accuracy of magnetic levitation technology, the print head unit can be movable in the vertical direction relative to the movement surface.

Thus, the vertical printing area and thus the vertical extension of the component to be produced can be increased to the sum of the maximum vertical movement dimension of the print head unit and the maximum vertical movement dimension of the at least one mover. At the same time, the low accuracy of the height adjustment can be compensated by the high accuracy of the magnetic levitation technology.

Since the movement of the at least one mover in the horizontal direction is basically not subject to any restriction, the design can be further simplified if the print head unit is movable relative to the at least one mover in the vertical direction only. Thus, the walls of the component to be manufactured are created by moving the at least one mover relative to the printing surface during the application of the printing medium to the printing surface.

The print head unit may be mounted in a fixed position on the at least one mover. Here, the print head unit is not movable in any direction relative to the at least one mover. However, it is also conceivable for the print head unit to be movably mounted on the at least one mover. Thus, the print head unit can be movable in vertical direction relative to the at least one mover, for example by means of a spindle drive. Also a relative movement of the print head unit in horizontal direction relative to the at least one mover is conceivable. Further, a control unit may be provided that is adapted to control both the movement of the at least one mover in the vertical direction and the movement of the print head unit in the vertical direction, in addition to the movement of the at least one mover in the horizontal direction.

In other words, a control unit can be provided that is set up to control the horizontal movement of the at least one mover as well as the vertical movement of the at least one mover and the vertical movement of the print head unit. In this way, the control unit can easily ensure that the positions of the print head unit and the mover are not controlled in opposite directions. Any unevenness of the printing surface can also be compensated for by the common control unit for the mover and print head unit.

In addition, the high accuracy of the positioning of the at least one mover, which is usually in the μm range, can be exploited in the horizontal direction in an advantageous manner. At the same time, the combination of the low accuracy of the height adjustment with simultaneously a large adjustment range in the vertical direction of the print head unit with the high accuracy of the height adjustment with only a small adjustment range in the vertical direction of the at least one mover results in the component application being precise and at the same time efficient. The achievable component height can also be improved by a print head unit that can be adjusted in the vertical direction, in particular by the joint control of the movement in the vertical direction by the print head unit and by the at least one mover. Furthermore, it can be provided that the movement surface can also be moved in vertical direction relative to the print bed unit. In this way, the achievable height of the component can be further increased.

In controlling the mover and/or print head unit, the control unit can control their movement trajectories while taking into account processes that are performed outside the device but extend into the movement surface. For example, the control unit can ensure that the mover and/or the print head unit move in such a way that a collision with an external robot arm performing a movement vertically and/or horizontally between the movement surface and the print bed unit can be avoided.

Also, the control unit may be arranged to control the movement of the print head unit in the horizontal direction, provided that the print head unit is movable in the horizontal direction.

In order to enable the supply of energy and media and/or a data connection with the control unit, the print head unit can have at least one supply line for printing medium to be applied and/or at least one data line, wherein the at least one supply line and/or the at least one data line can preferably be guided by at least one further mover, and/or can preferably be guided by a drag chain. Such guides of the at least one supply line and/or data line can prevent the at least one mover on which the print head unit is formed from colliding with a freely hanging line and thus interrupting the supply of the printing medium intended for application to the print head unit or the data communication with the print head unit.

In addition, lines, for example for conducting compressed air or water or the like, or for example for generating a negative pressure or vacuum, or for example for extracting fluids that arise, can also be provided in an analogous manner.

If several movers are provided, each mover can be assigned an area on the movement surface. To avoid collision with another print head unit, it is advantageous if each mover is assigned an area of the movement surface. Furthermore, the supply line and/or data line of the respective mover can be arranged only within this area of the mover.

To manufacture the component, the printing medium can be heated and then applied to the printing surface by the print head unit. In order to avoid too rapid cooling or even a thermal shock of the printing medium after it has left the print head unit, the printing surface can be heated. For this purpose, the printing surface can have a heating element. The provision of a heatable printing surface is thus possible in a simple manner.

For setting the temperature to a target value, the device may further comprise a temperature sensor. The temperature sensor can be connected to a temperature control unit via an electronic line. Alternatively, the temperature sensor and the temperature control unit can be connected to each other via a radio connection. According to a further alternative, the temperature sensor can be designed as an infrared camera. Advantageously, the control unit comprises the temperature control unit.

For high component quality in particular, it is important that the component manufacturing process is carried out in a room with as homogeneous a temperature distribution as possible or, if possible, without cold zones. To avoid costly air conditioning of the entire area in which the device is set up, for example a production hall, a print space housing can be provided that encloses the print head unit, the at least one mover and the printing surface.

This simplifies temperature control, in particular precise temperature control. At the same time, the energy consumption can be kept low, since the volume of the print space housing is smaller than the volume of the entire area in which the device is installed. A temperature-controlled print space housing also makes it possible to increase the range of print media for additive manufacturing of the component. Furthermore, emissions, such as toxic gases, can be generated when certain print media and printing processes are used, such as in laser metal sintering. The print space housing results in the emissions generated during the printing process being kept in the print space. In this way, the emissions that are produced/generated can be prevented from spreading to an area outside the print space housing.

Furthermore, in the device according to the invention, a plurality of print head units can be formed on the at least one mover. This allows several components to be printed simultaneously, for example components of the same design, which leads to an increase in the capacity of the device. With such a design of the device, a component can also be (further) built up at several points by one print head unit each, a so-called parallel printing. If light, in particular laser light, is used as the printing medium, the plurality of print head units can be arranged in such a way that the component is only produced by superimposing the light from two or more print head units. By superimposing the light, a sufficiently high energy density can be generated to cause selective curing and thus a layer-by-layer component buildup.

Additive manufacturing of a component by using different print media is also possible through the appropriate choice of print head units and print media. This makes it possible, for example, to produce multicolored components or even multicomponent parts. Advantageously, the control unit is set up to control the plurality of print head units together. This enables a synchronous printing process as well as an asynchronous printing process. This allows patterns to be applied, for example.

Alternatively or additionally, it is proposed that the device comprises more than one mover on which a print head unit is formed. In this way, the capacity of the device can be further increased, for example by allowing different print media to be applied simultaneously. Also, different print head units can be used, each of which is suitable for use with a different printing process. In this way, different printing processes can be used simultaneously or without the need for changeover. In addition, a reduction in downtimes, for example due to a change of printing medium, a malfunction or maintenance of a print head unit, can be achieved because another mover with a print head unit is available.

In view of the fact that the main focus of the invention is the construction of the device and the movement of the print head unit, it should be noted at this point that standard printing processes, in particular filament extrusion processes or jetting processes, can be used to manufacture the component. Furthermore, sintering processes, electron beam melting processes, stereolithography processes or melt layer processes can be used to manufacture the component. Thus, for example, all conventional extrudable or sprayable materials, for example plastics, in particular thermoplastic plastics, or metals can be used for the production of the component.

### BRIEF DESCRIPTION OF THE DRAWINGS

The invention will be explained in more detail below by means of an embodiment with reference to the accompanying drawings.

FIG. 1 shows a cross-sectional view of a first embodiment of the device according to the invention;

FIG. 2 shows a perspective view of a second embodiment of the device according to the invention; and

FIG. 3 shows a cross-sectional view of a third embodiment of the device according to the invention.

### DETAILED DESCRIPTION

In FIG. 1, a device for additive manufacturing of a component is very generally designated 100. The device 100 comprises a print head unit 102 and a print bed unit 104.

A printing surface 106 is formed on the print bed unit 104 on a surface 104a facing towards the print head unit 102. The print head unit 102 is adapted to apply a printing medium 108 to the printing surface 106 of the print bed unit 104 to form a component 110 not belonging to the device 100. For example, an application method, such as fusion application, could be used for this purpose.

Further, the device includes a system 112 formed in magnetic levitation technology. The system 112 includes a stator assembly 114 and at least one mover 116. The stator assembly 114 includes a movement surface 114a relative to which the at least one mover 116 can move.

According to the present invention, the print head unit 102 is formed on a surface 116a of the at least one mover 116 facing towards the printing surface 106. According to the present embodiment, the print head unit 102 and the at least one mover 116 are positively connected or frictionally connected to each other.

The at least one mover 116 can move on the movement surface 114a in both a horizontal direction h, parallel to the movement surface 114a, and a vertical direction v (also referred to as a height direction), orthogonal to the movement surface 114a.

The movement surface 114a is arranged in a vertical direction v above the print bed unit 104, in particular the printing surface 106. Here, the print head unit 102 protrudes in the vertical direction v downwardly from the at least one mover 116 facing the printing surface 106. In other words, the print head unit 102 is formed suspended above the printing surface 106 from the at least one mover 116.

Further, the device 100 comprises a holding unit 118 adapted to hold the at least one mover 116 on the movement surface 114a of the stator assembly 114. The holding unit 118 is arranged such that it does not impede the free movement of the at least one mover 116 both in the vertical direction v and in the horizontal direction h. Only in the event of an unintentional detachment of the at least one mover 116 from the movement surface 114a, for example due to a disturbance of the magnetic field generated by the stator assembly 114, the holding unit 118 causes the at least one mover 116 to move away from the movement surface 114a at most to such an extent that the print head unit 102 formed on the at least one mover 116 just does not touch the component 110.

According to the present embodiment, the holding unit 118 comprises a suction device 118a that can be activated by a signal. Alternatively or additionally, a conventional holding unit may also be provided.

While the at least one mover 116 is movable relative to the movement surface 114a both in the horizontal direction h and in the vertical direction v, in the case of the present embodiment the print head unit 102 can only move in the vertical direction v relative to the at least one mover 116. In this way, the high accuracy of the positioning of the at least one mover 116 in the horizontal direction h can be exploited in an advantageous manner. At the same time, the combination of the low accuracy of the height adjustment with simultaneously a large adjustment range in the vertical direction v of the print head unit 102 with the high accuracy of the height adjustment with only a small adjustment range in the vertical direction v of the at least one mover 116 results in the component application being precise and at the same time efficient.

The efficiency of the additive manufacturing is further improved by providing a control unit 120 adapted to control the movement of the at least one mover 116 in horizontal direction h and vertical direction v. Further, the control unit 120 is adapted to control the movement of the print head unit 102 in the vertical direction v. This joint control of the print head unit 102 and the at least one mover 116 by the control unit 120 not only reduces the control effort and the complexity of the device 100, but also prevents the positions of the print head unit 102 and the at least one mover 116 from being controlled in opposite directions. Furthermore, joint control of the movement in the vertical direction v by the print head unit 102 and by the at least one mover 116 can improve the achievable component height.

The complexity of the printing process may be further reduced by having the print head unit 102 include at least one line 122. The at least one line 122 may be configured as a supply line 122a for printing medium 108 to be applied alternatively or additionally, at least one further line 122 may be provided which is configured as a data line 122b. In order to prevent the at least one (further) line 122 from hindering or impeding the movement of the at least one mover 116 relative to the movement surface 114a, the at least one mover 116 has a guide unit 124. The guide unit 124 is adapted to guide the at least one (further) line. Alternatively or additionally, a drag chain (not shown) may be provided to guide at least one (further) line. For this purpose, for example, a drag chain can be used, such as is known to the person skilled in the art.

In principle, the device 100 according to the invention is suitable for the use of standard printing processes. For example, printing processes can be used in which it is advantageous if the printing surface 106 can be heated. For this purpose, a heating element 126 is provided in the print bed unit 104.

To facilitate temperature control, the device 100 further comprises a temperature sensor 128. The temperature sensor 128 detects the current temperature at a predetermined location of the device 100. The control unit 120 may be configured to set a target temperature value based on the actual temperature value measured by the temperature sensor 128. For this purpose, the control unit 120 may control the heating element 126.

Temperature control is further simplified by providing a print space housing 130 that encloses the print head unit 102, the at least one mover 116, and the printing surface 106. The temperature sensor 128 is preferably disposed within the print space housing 130.

In order to apply a component 110, the at least one mover 116 moves with the print head unit 102 formed on the at least one mover 116 to a specific position on the movement surface 114a at which the print head unit 102, initiated by the control unit 120, starts the printing process. When the printing process (additive manufacturing) begins, the print head unit 102 starts to apply printing medium 108 to the printing surface 106 of the print bed unit 104.

Meanwhile, the control unit 120 controls the movement of the at least one mover 116 and the movement of the printing unit 102 such that the coordinated movement, together with the application of the printing medium 108, results in the formation of the desired component 110 on the printing surface 106.

Once the additive manufacturing process of the component 110 is complete, the at least one mover 116 may move to another position on the movement surface 114a. The control unit 120 can cause the print head unit 102 to begin manufacturing another component, regardless of whether or not the previously manufactured component 110 is still on the printing surface 106. This can reduce the downtime of the apparatus 100.

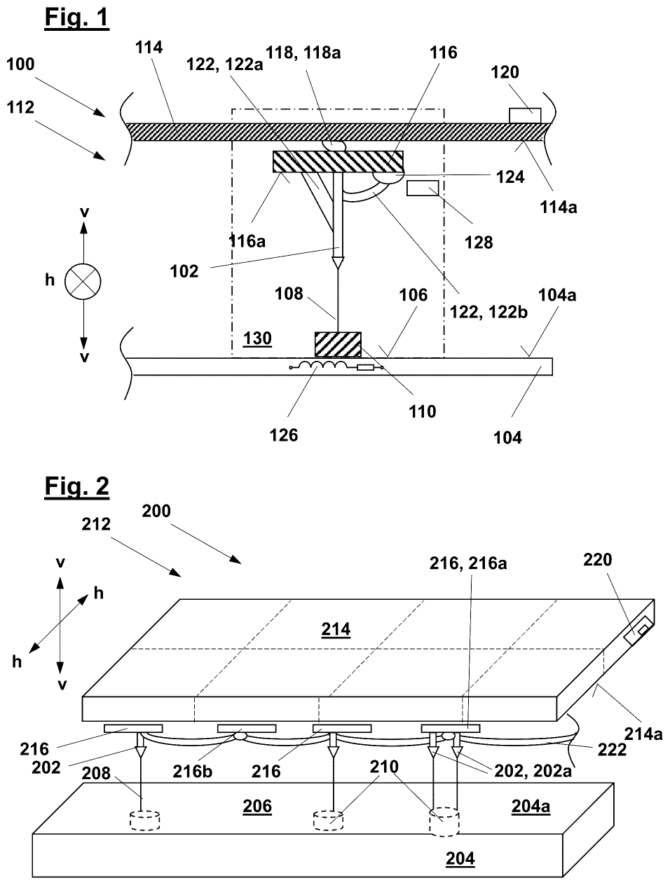

FIG. 2 shows a device 200 according to a second embodiment, which essentially corresponds to the device 100 according to the first embodiment. Therefore, in FIG. 2, the same components are provided with the same reference numerals as in FIG. 1, but increased by 100. Furthermore, the device 200 will be described below only with respect to its differences from the device 100, the description of which is otherwise expressly referred to herein.

The device 200 includes a printing surface 206 formed on a surface 204a of a print bed unit 204. The printing surface 206 faces a movement surface 214a of a stator assembly 214 of a system 212 formed in magnetic levitation technology. At least one mover 216 can move on the movement surface 214a.

The device 200 includes a plurality of movers 216, and a plurality (in this case, two) of print head units 202a are disposed on a mover 216a. Each of the print head units 202a of the mover 216a is configured to apply a component 210 to a printing surface 206. A control unit 220 can control each of the print head units 202a such that two print head units 202a move synchronously or asynchronously with each other.

Further, the device 200 has more than one mover 216 (two in this case) on which a print head unit 202 is formed. The control unit 220 is arranged to control each of the movers 216 independently of the other movers 216 movable on the movement surface 214a. In this way, several different components 210 can be applied to the same printing surface 206.

A further mover 216b is provided to guide a line 222.

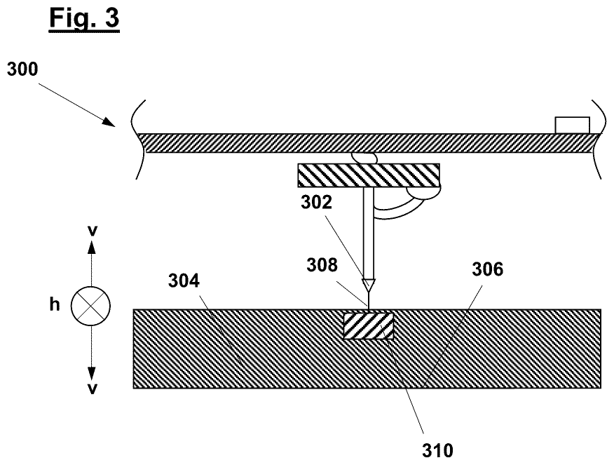

FIG. 3 shows a device 300 according to a third embodiment, which essentially corresponds to the device 100 according to the first embodiment and the second device 200 according to the second embodiment. Therefore, in FIG. 3, the same components are provided with the same reference numerals as in FIGS. 1 and 2, but increased by 100 and 200, respectively. Furthermore, the device 300 will be described below only with respect to its differences from the device 100 and the device 200, the description of which is otherwise expressly referred to herein.

In the present embodiment, the print bed unit 304 is in the form of a print bed container. At least one print head unit 316 applies light or an electron beam as a printing medium 308 to a printing surface 306, so that a component 310 is formed in the print bed container.

The device 300 may be used for employing selective laser sintering or printing methods based on the stereolithography principle.

1. Device for additive manufacturing of a component not belonging to the device, comprising:
a print head unit arranged to apply a printing medium intended for forming the component to a printing surface;
a print bed unit having a surface facing toward the print head unit on which the printing surface is formed; and
a system formed in magnetic levitation technology comprising a stator assembly and at least one mover, the stator assembly having a movement surface relative to which the at least one mover is moveable,
wherein the print head unit is formed on a surface of the at least one mover facing toward the printing surface.

2. Device according to claim 1,
wherein the device further comprises a holding unit adapted to hold the at least one mover on the movement surface.

3. Device according to claim 2,
wherein the holding unit comprises a suction device which can be activated by a signal and/or has a self-holding function.

4. Device according to claim 1,
wherein the at least one mover is movable relative to the movement surface both in a horizontal direction and in a vertical direction.

5. Device according to claim 1,
wherein the print head unit is movable in a vertical direction relative to the movement surface.

6. Device according to claim 1,
wherein the print head unit is movable relative to the at least one mover only in a vertical direction.

7. Device according to claim 5,
wherein a control unit is provided which is set up to control, in addition to the movement of the at least one mover in a horizontal direction, both the movement of the at least one mover in the vertical direction and the movement of the print head unit in the vertical direction.

8. Device according to claim 1,
wherein the print head unit has at least one supply line for the printing medium to be applied and/or at least one data line, the at least one supply line and/or the at least one data line preferably being guided by at least one further mover and/or preferably being guided by a drag chain.

9. Device according to claim 1,
wherein the device further comprises a temperature sensor.

10. Device according to claim 1,
wherein a print space housing is provided that encloses the print head unit, the at least one mover, and the printing surface.

11. Device according to claim 1,
wherein a plurality of print head units are formed on the at least one mover.

12. Device according to claim 1,
wherein the at least one mover comprises more than one mover on which a print head unit is formed.
